(19) United States
(12) Patent Application Publication
(10) Pub. No.: US 2021/0372164 A1
(43) Pub. Date: Dec. 2, 2021

(54) ELECTROMECHANICAL LOCK

(71) Applicant: Klaus W. Gartner, Palos Verdes Estates, CA (US)

(72) Inventor: Klaus W. Gartner, Palos Verdes Estates, CA (US)

(21) Appl. No.: 16/887,076

(22) Filed: May 29, 2020

(51) Int. Cl. E05B 47/00; E05B 47/06; E05B 37/08

(52) U.S. Cl. CPC E05B 47/0012; E05B 37/08; E05B 47/0688

(57) ABSTRACT

An electromechanical lock having a locking mechanism that includes a feature that automatically returns the lock to secure position is provided. The locking mechanism ensures that the locking bolt cannot move back into the unlocked position without an authorized code being reentered.

### FIELD OF THE INVENTION

The present invention is related to the field of electromechanical locks. More particularly, this invention relates to an electromechanical lock for securing goods and areas requiring a high degree of security.

### BACKGROUND OF THE INVENTION

Doors of safes, vaults, strong rooms, containers and similar security closures (collectively, “containers”) usually have at least one and frequently several safe bolts that reciprocate from a non-locking position to an extended locking position. Generally in the locking position, a bolt extends from the lock mounted on the container door into an adjacent container wall. In the unlocked position the bolt retracts into the lock.

Rectilinear bolt locking devices operate in a such a manner. In particular, rectilinear bolt locking devices mount a bolt within a housing for moving between locked and unlocked positions. When the user enters the correct combination into the electronic lock, the lock mechanism allows the locking bolt to slide into the housing.

When the lock is used to secure entry to a container, the electronic components are typically mounted on a housing inside the container door. The housing contains a battery and a circuit board having electronic circuitry that controls the lock. A keypad is on the outside of the housing so as to be accessible to the user. A cable typically extends between the keypad and the circuit board for transmitting signals between the two components.

An electronic combination entry system controls an actuation device located within the lock housing. Typically, a user enters the combination through a digital input pad. If the combination is an authorized combination, the electronic circuitry sends an electrical signal to the circuit board, which in turns actuates the actuating device and allows a locking mechanism to disengage the locking bolt. The user rotates a handle on the outside of the container which in turn manipulates the bolt works. Part of the bolt works engages the locking bolt and causes it to move to the unlocked position. The locking bolt then retracts into the housing allowing the user to open the container door.

Unfortunately, mechanisms such as the one described above have limitations. After the lock has been opened the user rotates the handle again to cause the locking bolt to move to the locked or fully extended position in the container wall. However, in the locking cycle after the bolt is fully extended, the user must rotate the dial at least one full rotation to ensure the lock cannot be reopened. In other words, if the user does not keep rotating the dial at least one full rotation, the lock can actually be unlocked again. This poses a problem that would effectively allow unauthorized access into the safe despite the appearance that the locking bolt is in the locked position.

Accordingly, what is needed is a locking mechanism that includes a feature that automatically returns the lock to secure position that ensures that the locking bolt cannot move back into the unlocked position without an authorized code being reentered.

### BRIEF SUMMARY OF THE INVENTION

The problems outlined above are addressed by the electronic lock in accordance with the invention. The invention solves the foregoing problems by providing a lock having a locking mechanism housed within a housing, the housing having an opening for a rectilinear locking bolt.

In one aspect an electromechanical lock having a housing including a drive cam with at least one receiving slot thereon, a shaft engaged with the drive cam and a dial rotatably coupled to the shaft is disclose.

In another aspect a locking bolt is received within the housing and is moveable between a locked and an unlocked position.

In another aspect a locking mechanism is disclosed, the locking mechanism including a lower lever portion and a pivotal upper lever portion, the lower lever portion including a nose portion engageable with the at least one receiving slot and an arm portion including a cavity for housing a motor, the motor rotatably engageable with the upper lever portion such that upon actuation, the motor causes the upper lever portion to pivot from a first locked position to a second open position.

In another aspect of the invention in the open position the nose portion is configured to engage the at least one receiving slot and the locking bolt retracts from the locked position to the unlocked position.

In another aspect of the invention, the upper lever portion includes a first post received by an arcuate slot in the lower lever portion that allows the upper lever portion to pivot from the first locked position to the second open position.

In yet another aspect of the invention the locking mechanism includes a fence having a fence post thereon, the fence pivotally coupled to the lower lever portion.

In another aspect a slider is received within a pocket in the housing, wherein the pocket includes a pocket angled edge and a pocket straight edge.

In another aspect the fence post is configured to engage the pocket straight edge in the locked position and moveably engages the pocket angled edge to automatically return the upper locking lever to the locked position.

In another aspect in order to open the locking bolt, a user enters an authorized code into a keypad that forms part of the lock and activates an actuator. A rotatable bar coupled to the actuator rotates from a first position in which the locking bolt is locked to a second position in which a compression spring in a pre-loaded position releases its load. The user then rotates a handle on the outside of the container which in turn causes the cam drive to rotate. When a receiving slot on the cam drive aligns with a nose portion on the locking lever, the nose portion drops into the receiving slot on the cam drive allowing a user to turn the dial and the locking bolt retracts into the open position. As the locking bolt to moves to the unlocked position, the upper locking lever goes directly into a secure mode. The user can then rotate the handle again and close the lock.

These and other features will now be described in detail.

### BRIEF DESCRIPTION OF THE DRAWINGS

For a better understanding of the invention, and to show how the same may be carried into effect, reference will now be made, by way of example, to the accompanying drawings, in which:

FIG. 1 is a perspective view of the lock in accordance with the invention positioned on a container.

FIG. 2A is a side front view of the lock in accordance with the invention showing the locking mechanism in the locked position and the locking bolt in the locked position.

FIG. 2B is a perspective view of the locking mechanism in the locked position.

FIG. 2C is a view of the proximal portion of the locking lever engaged with a compression spring positioned in the face of the locking bolt.

FIG. 2D is a front view of the locking mechanism in the locked position as it is positioned in the face of the locking bolt.

FIG. 2E is a back view of the locking mechanism showing the compression spring in the semi-circular channel.

FIG. 3 is a side front view of the lock in accordance with the invention showing the locking mechanism in the unlocked position with the nose dropped into the drive cam and the locking bolt in the locked position.

FIG. 4 is a side front view of the lock in accordance with the invention showing the locking mechanism reverted to the locked position and the locking bolt in the unlocked position.

FIG. 5 is a side back view of the lock as shown in FIG. 3.

FIG. 6 is a side back view of the lock showing the slider engaged.

### DETAILED DESCRIPTION OF THE INVENTION

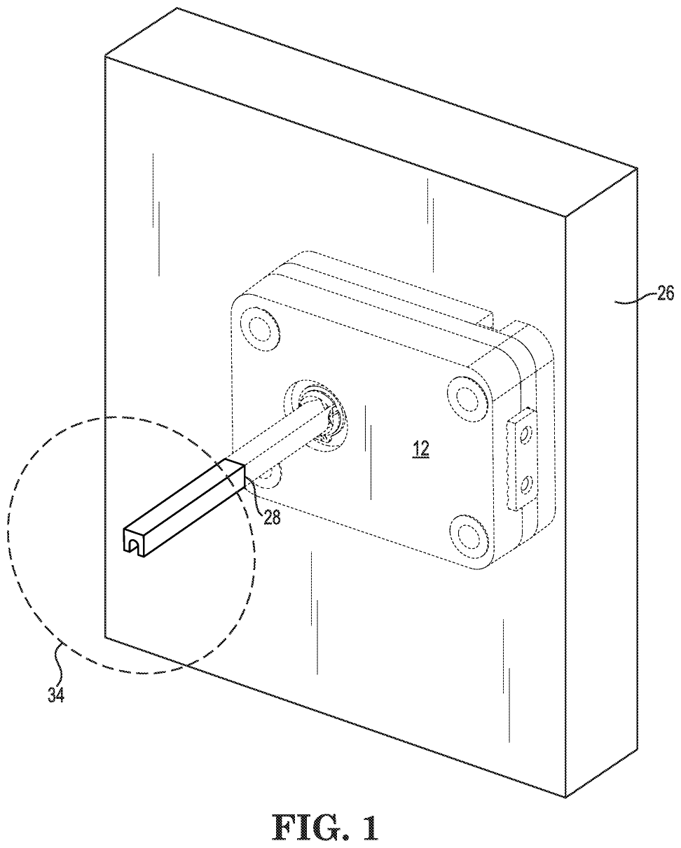

Referring to FIG. 1 an electromechanical lock is shown mounted to a secure container. Housing 12 is mounted to wall 26. Wall 26 is representative of the door of a safe, a container or secure room. Shaft 28 operably engages cam drive 14 and extends through wall 22 where it mates with an electronic keypad (not shown).

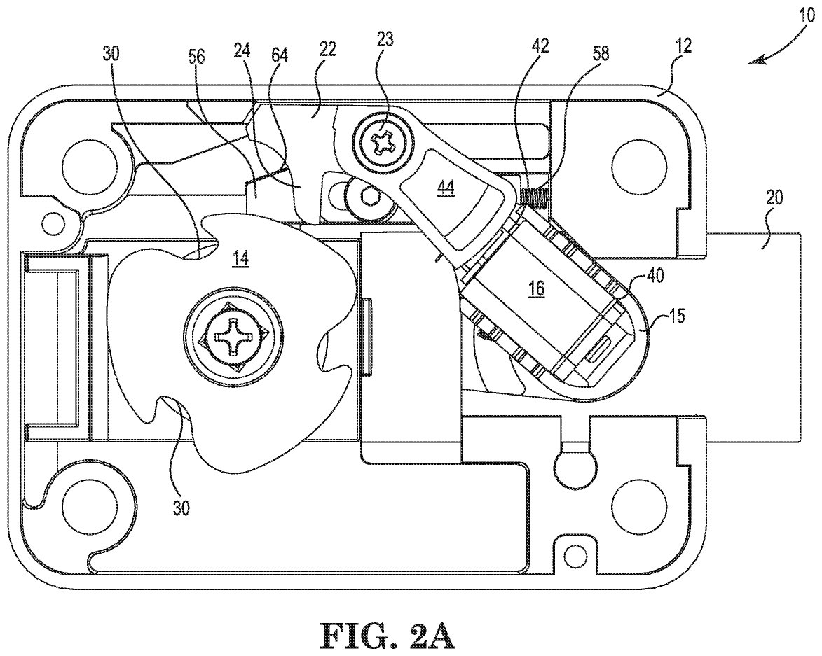

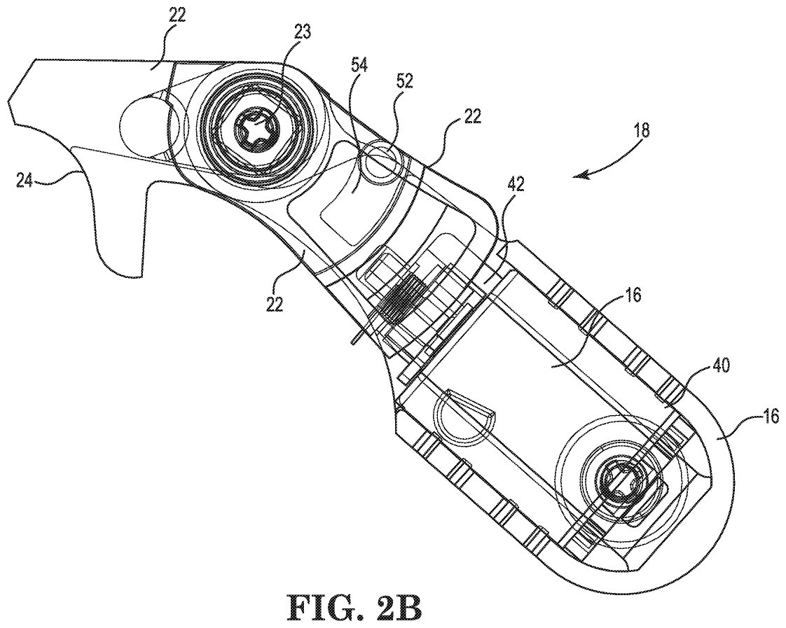

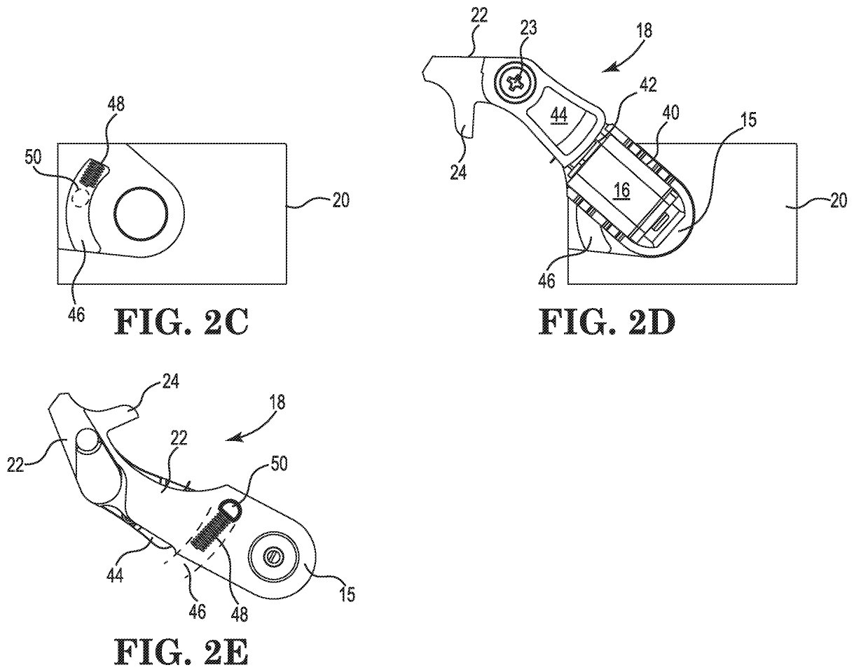

Referring FIGS. 2A and 2B aspects of an electromechanical lock 10 in accordance with the invention are depicted. Electromechanical lock 10 broadly includes housing 12, cam drive 14, actuating device 16, locking mechanism 18 and rectilinear lock 20. In another aspect of the invention, locking mechanism 18 includes lever 22 having a one-piece construction and includes nose portion 24 at the distal end thereof and arm portion 15 at the proximal end thereof. Arm portion 15 includes a cavity 40 for housing actuating device 16 therein. Locking lever upper portion 44 is coupled to a mid-portion of lever 22 by fastening means 23. As best seen in FIG. 2B, locking lever upper portion post 52 is received in arcuate slot 54 in lever 22 allowing the locking lever upper portion 44 to travel from a first locked position to a second open position and back to the locked position. FIG. 2A shows the lock in the locked “home” position.

Actuating device 16 may be a rotary motor or like alternatives known to those of ordinary skill in the art. Actuating device includes a rotatable bar 42 rotatably responsive to the output of actuating device 16. Cam drive 14 includes one or more receiving notches 30 for matingly engaging nose portion 24.

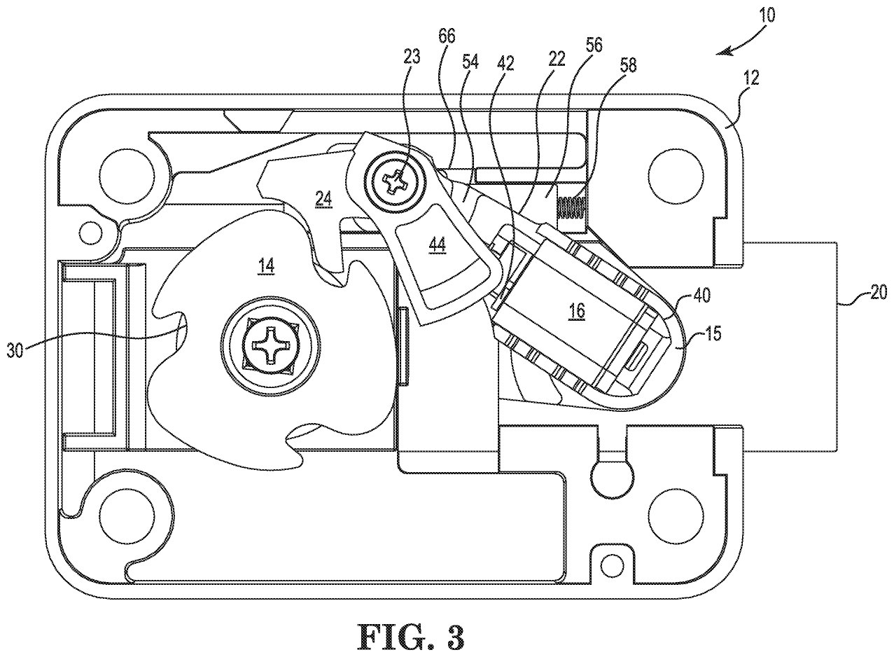

Referring FIG. 2A-2E the locking mechanism 18 is shown in the locked position. The locking lever upper portion 22 is in a first position on arm portion 15 and nose 24 is not in engagement with a receiving notch 30 on cam drive 14. As can be seen, rectilinear locking bolt 20 is in the extended or locked position. The face of a proximal portion of rectilinear locking bolt 20 includes a semi-circular channel 46 into which first compression spring 48 fits as best seen in FIG. 2C. Stop 50 holds compression spring in the loaded position when being assembled. When an authorized combination is input in to the keypad a signal from the circuit board with which the keypad communicates is sent to actuating device 16 which rotates the cam 14 and allows nose portion to drop into one of the receiving notches 30 and the upper locking lever 22 to move from the locked position to the unlocked position as shown in FIG. 3

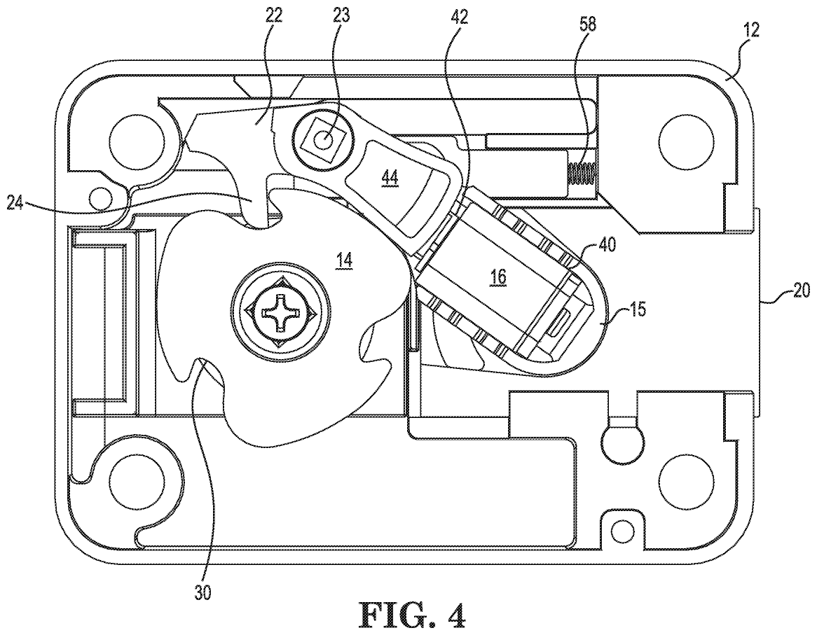

Referring now to FIG. 3 is a side front view of the lock in accordance with the invention showing the locking mechanism in the unlocked position with the nose dropped into a receiving notch 30 of drive cam 14 with the locking bolt 20 still in the locked position. Now that the locking mechanism 18 is in the open position a user can rotate dial 34 and further rotate cam 14 until the locking bolt 20 is fully retracted into the open position as best seen in FIG. 4. As can also be seen the upper locking lever 44 has automatically reverted to the locked position by a mechanism which will now be described.

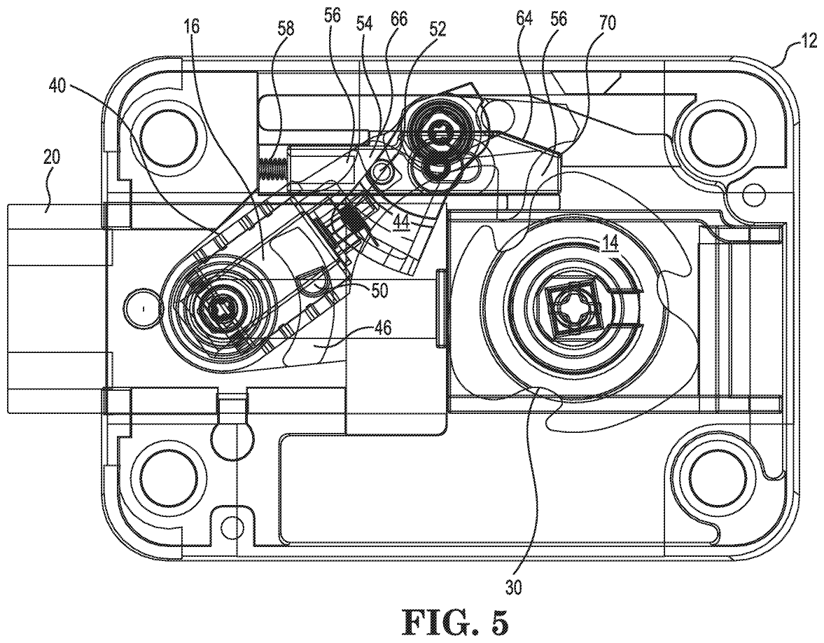

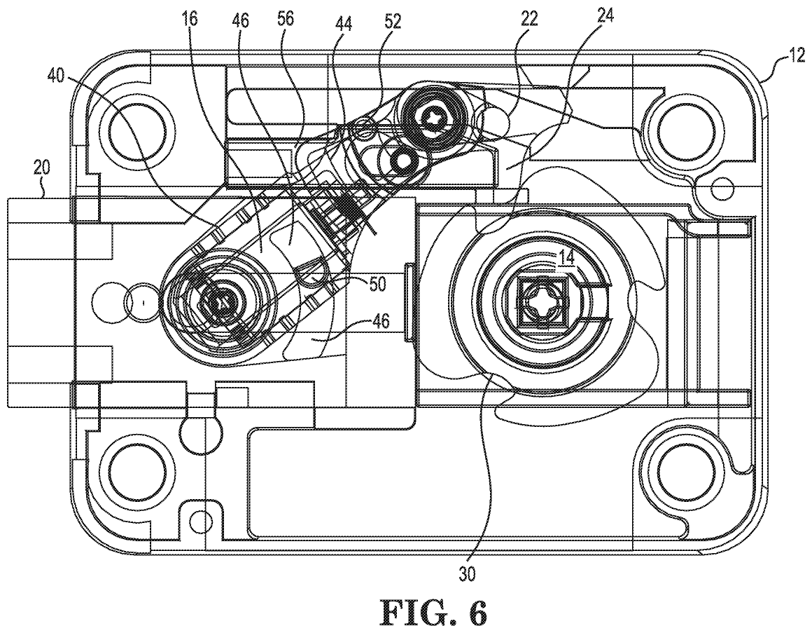

Referring now to FIGS. 4 and 5-6 the locking mechanism 18 in accordance with the invention also includes elongate slider 56, second compression spring 58, fence 60 and fence post 62. Fence 60 is moveably coupled to lever 22 at the nose portion 24. Elongate slider 56 includes an angled edge 64 and a top straight edge 66 and is slidably received within a pocket molded in housing 12. Pocket includes a top straight edge 68 a mating angled edge 70 into which elongate slider 56 is received. In the locked position, fence post 62 is positioned on the pocket straight edge 68 between the end of pocket straight edge 68 and the beginning of pocket angled edge 70. Second compression spring 58 is received within a channel in slider 56. When the locking mechanism is in the open position, the fence post 62 engages pocket angled edge 70. When the fence post 62 reaches the bottom of the pocket angled edge 70 it snaps back and automatically causes the locking lever upper portion 44 to return to the locked position. When the locking lever upper portion 44 returns to the locked position, the cam drive 14 is pushing the lever 22 and bolt 22 to the locked position. At the same time the fence 60 engages the slider 56 and second spring 58 compresses as the slider 56 slides back slightly allowing the locking mechanism 18 to revert to the “home” position. If the slider 56 were not present the locking mechanism 18 would not revert to the home position.

When a code or combination is input into the electronic keypad, a signal is transmitted to a circuit board located within the housing 12 which recognizes the code as an authorized or unauthorized code. If the code is an authorized code, a signal is sent to the actuating device 16 via one or more contact points (not shown), which in turn causes rotatable bar 42 to rotate from the first locked position to a second open position. As the user turns the dial 34 to retract locking bolt 20, at least one receiving notch 30 of drive cam 14 aligns with nose 24 as compression spring releases and causes nose 24 to drop into receiving notch 30 on cam drive 16.

As dial 34 is turned and the rectilinear locking bolt 20 retracts to the open or unlocked position, locking lever upper portion 44 automatically reverts to the locked position due to a slider mechanism 38 as described below.

As the user continues to manually rotate drive cam via dial 34 fence post 62 travels down pocket angled edge and reverts automatically to the locked position. When the locking mechanism is in the open position, the fence post 62 engages pocket angled edge 70. When the fence post 62 reaches the bottom of the pocket angled edge 70 it automatically causes the locking lever upper portion 44 to return to the locked position. When the locking lever upper portion 44 returns to the locked position and the user has finished retrieving goods from the container the user turns or rotates dial 32 to lock the container. The rotation of shaft 24 causes the cam drive 14 to turn clockwise and the nose 24 exits the receiving notch 30 on the cam drive 14. The cam drive 14 pushes the lever 22 and bolt 22 to the locked position. At the same time the fence 60 engages the slider 56 and second spring 58 compresses as the slider 56 slides back slightly allowing the locking mechanism 18 to revert to the “home” position. The locking mechanism 18 remains in the locked position 34 and the locking bolt 20 returns to the fully extended or locked position.

Although the present invention has been described with reference to exemplary embodiments, workers skilled in the art will recognize that changes may be made in form and detail without departing from the spirit and scope of the invention.

What is claimed:

1. An electromechanical lock comprising:
a housing including a drive cam having at least one receiving slot thereon, a shaft engaged with the drive cam and a dial rotatably coupled to the shaft;
a locking bolt received within the housing and moveable between a locked and an unlocked position;
a locking mechanism including a lower lever portion and a pivotal upper lever portion, the lower lever portion including a nose portion engageable with the at least one receiving slot and an arm portion including a cavity for housing a motor, the motor rotatably engageable with the upper lever portion such that upon actuation, the motor causes the upper lever portion to pivot from a first locked position to a second open position,
wherein in the open position the nose portion is configured to engage the at least one receiving slot and the locking bolt retracts from the locked position to the unlocked position.

2. The electromechanical lock of claim 1 wherein the upper lever portion includes a first post received by an arcuate slot in the lower lever portion which is configured to allow upper lever portion to pivot from the first locked position to the second open position.

3. The electromechanical lock of claim 1 further comprising a fence having a fence post thereon, the fence pivotally coupled to the lower lever portion.

4. The electromechanical lock of claim 3 further comprising a slider received within a pocket in the housing.

5. The electromechanical lock of claim 4 wherein the pocket includes a pocket angled edge and a pocket straight edge.

6. The electromechanical lock of claim 5 wherein the fence post engages the pocket straight edge in the locked position and moveably engages the pocket angled edge to automatically return the upper locking lever to the locked position.
